(19) United States
(12) Patent Application Publication
(10) Pub. No.: US 2005/0172806 A1
(43) Pub. Date: Aug. 11, 2005

(54) Method and apparatus for filtering

(76) Inventor: Rodney Olson, Yucaipa, CA (US)

Correspondence Address: J MARK HOLLAND & ASSOCIATES, 3 CIVIC PLAZA SUITE 210, NEWPORT BEACH, CA, 92660, US

(21) Appl. No.: 10/775,494

(22) Filed: Feb. 10, 2004

(51) Int. Cl. B01D 53/02

(52) U.S. Cl. 95/148

(57) ABSTRACT

The present invention describes an improved method and apparatus for, among other things, a periodic deposit of a chemical fluid on a regenerate contact surface for the continuous removal of at least one constituent, preferably an odor-causing agent, from a gas. In one embodiment the apparatus for removal of odor from a gas preferably includes an adsorber for the continual removal of an odor-causing agent from a gas. The adsorber preferably includes a sump, a media bed, an exhaust chamber, a chemical fluid entering the exhaust chamber, a regenerate contact surface formed by a periodic deposit of the chemical fluid from the exhaust chamber on the media bed, and a control means for controlling the periodic deposit of the chemical fluid. The sump preferably includes a gas inlet for receiving the gas, and the absorber is configured to allow the gas to flow from the gas inlet to the regenerate contact surface so that at least some of the odor-causing agent is retained by the chemical fluid upon contact of the odor-causing agent with the chemical fluid thereby reducing the amount of odor-causing agent in the gas flowing out the exhaust chamber.

### FIELD OF INVENTION

The present invention generally relates to fluid treatment. More particularly, the present invention relates to an improved method and apparatus for, among other things, a periodic deposit of a chemical fluid on a regenerate contact surface for the continuous removal of at least one constituent from a gas.

### INCORPORATION BY REFERENCE

The contents of each U.S. patent or other reference, if any, cited in this application, are hereby incorporated by reference.

### BACKGROUND OF INVENTION

Two forms of sulfur are typically found in water supplies: sulfate and hydrogen sulfide (H₂S). Sulfates are a combination of sulfur and oxygen and are part of naturally occurring minerals in some soil and rock formations that contain groundwater. The minerals dissolve over time and are released into the groundwater.

The other form of sulfur, hydrogen sulfide, may be produced by sulfur-reducing bacteria, which use the sulfur as an energy source. These anaerobic (without oxygen) bacteria use sulfur and sulfate compounds found in decaying plant material, rocks or soil to convert organic compounds into energy. Under these anaerobic conditions, the bacteria chemically change natural sulfates in water to hydrogen sulfide. As a gas, hydrogen sulfide produces an offensive odor that smells like rotten eggs” and has a characteristic “sulfur water” taste in the water.

The present invention is discussed herein primarily with respect to the removal of hydrogen sulfide from a gas, but it can be adapted to address other contaminants or non-contaminants herein referred to as constituents whether or not they are odor-causing.

The nuisances associated with hydrogen sulfide include not only its foul odor, but also (among other things) its corrosiveness to metals such as iron, steel, copper, brass, and other exposed metal. Among other things, such corrosion can damage parts in washing machines and other water-using appliances. Corrosion of iron and steel by hydrogen sulfide forms a black precipitate (ferrous sulfide) that can stain laundry and bathroom fixtures, darken silverware and discolor copper and brass utensils. Hydrogen sulfide also can cause yellow or black stains on kitchen and bathroom fixtures. High concentrations of dissolved hydrogen sulfide also can foul the resin bed of an ion exchange water softener.

The odor of water with as little as 0.5 ppm (parts-per-million) of hydrogen sulfide concentration is detectable by most people. Concentrations less than 1 ppm give the water a “musty” or “swampy” odor. A 1-2 ppm hydrogen sulfide concentration gives water a “rotten egg” odor and makes the water very corrosive to plumbing. Generally, hydrogen sulfide levels in water are less than 10 ppm, but have been reported as high as 50-75 ppm.

A number of treatments exist to try to remove hydrogen sulfide from water. For example, activated carbon filters may be installed to absorb low levels of soluble organic compounds and certain gases, such as chlorine and hydrogen sulfide that contribute tastes and odors to a water supply. Activated carbon may be used in a granular form in tank-type filters and as finely divided powder in a cartridge. The hydrogen sulfide is adsorbed onto the surface of the carbon particles. Some filters will improve taste, but will not eliminate unpleasant odors. In such systems, the filter must typically be backwashed and replaced periodically to maintain performance. Frequency of backwashing and replacement will depend on daily water use and concentrations of hydrogen sulfide in the water.

Alternatively, aeration (adding air to the water) is a treatment option and is commonly used by city water treatment systems. Oxygen reacts with hydrogen sulfide to form an odorless, dissolved form of sulfur called sulfate. However, the aeration process releases hydrogen sulfide gas into the surrounding atmosphere causing a pollution problem and, possibly, problems relating to toxicity. (U.S. Pat. No. 4,264,451 to Pope et al.) In addition, the air must then be removed from the water to prevent knocking or air-blocks in the system and to reduce the corrosion potential caused by dissolved oxygen.

One alternative to aeration is the use of shock chlorination/disinfection of the water source that may temporarily control hydrogen sulfide. Shock chlorination uses a single high dose of chlorine placed in direct contact with water. If used in sufficient concentration and with adequate contact time, chlorine is an excellent disinfectant that kills most odor-causing bacteria, viruses and cysts of protozoans. It also kills nonpathogenic iron, manganese, and sulfur bacteria. In some situations the use of chlorine along with activated carbon to remove hydrogen sulfide in wastewater supplies may be needed.

Other examples of hydrogen sulfide control mechanisms include the use of chlorine or hydrogen peroxide (H₂O₂) in multiple column scrubbers. Typical scrubbers operate by combining gaseous H₂S with a chemical liquid such as sodium hydroxide (NaOH) and water and passing the mixture over a reaction bed or media to extract the H₂S from the gas. According to one source at www.h2o2.com, generally, the simplest and most reliable type of scrubber for this purpose is a packed-bed tower operated counter-currently; the hydrogen sulfide gas is moved upwards and the liquid hydrogen peroxide is moved downward. As this process requires an uninterrupted stream of chemical liquid to contact the constant influx of gas, large amounts of chemicals and water are typically consumed. Furthermore, as machinery must be operated continuously to move the chemical liquid, the need for maintenance on such equipment is typically higher than on systems operating less often.

Another type of scrubber relates to scrubbing waste gases with an absorbent suspension and removing the adsorbed pollutant from the suspension by biodegradation in a subsequent reactor. Preferably the gas and liquid medium are retained for a period of time in a column or large shallow bed so that materials are intimately mixed. However, as indicated in U.S. Pat. No. 6,143,553 to Teller, bioscrubbers have heretofore been inadequate. The flow rates needed for real-world applications have not generally been attainable unless columns and reactors of excessive size are considered. Further the bioscrubbers have generally not been sufficiently efficient to operate alone and instead must be combined with other units.

Accordingly, there is need for a method and apparatus for the removal of at least one constituent, preferably an odor-causing agent, from a gas that is more reliable, efficient, highly effective, operates more economically than known devices, and is capable of automatic and/or continuous odor-causing agent removal.

### SUMMARY

The present invention describes an improved method and apparatus for, among other things, a periodic deposit of a chemical fluid on a regenerate contact surface for the continuous removal of at least one constituent, preferably an odor-causing agent, from a gas.

For the purpose of summarizing the invention certain objects and advantages have been described herein. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a schematic diagram of an apparatus for the removal of at least one constituent of a gas.

FIG. 2 shows a cut-away view of the adsorber shown in FIG. 1.

FIG. 3 is a flow chart illustrating a method of removing a constituent from a gas in accordance with the present invention.

FIG. 4 is a flow chart illustrating an alternative method of removing a constituent from a gas in accordance with the present invention.

### DETAILED DESCRIPTION

Embodiments of the present invention will now be described with references to the accompanying Figures, wherein like reference numerals refer to like elements throughout. The terminology used in the description presented herein is not intended to be interpreted in any limited or restrictive manner, simply because it is being utilized in conjunction with a detailed description of certain embodiments of the invention. Furthermore, various embodiments of the invention (whether or not specifically described herein) may include novel features, no single one of which is solely responsible for its desirable attributes or which is essential to practicing the invention herein described.

The present invention describes an apparatus for removing a constituent, preferably an odor-causing agent, from a gas. Although the present invention is described herein as an apparatus for the removal of an odor-causing agent from a gas, persons of ordinary skill in the art will understand that the apparatus may be utilized to remove generally any constituent from a gas.

As used herein, the term “constituent” is a broad term generally used in its ordinary meaning and includes, without limitation those parts/elements necessary in forming or making up a whole or end item. In other words, the apparatus may generally be used to remove any contaminant and/or non-contaminant whether it is odor-causing or not from a gas.

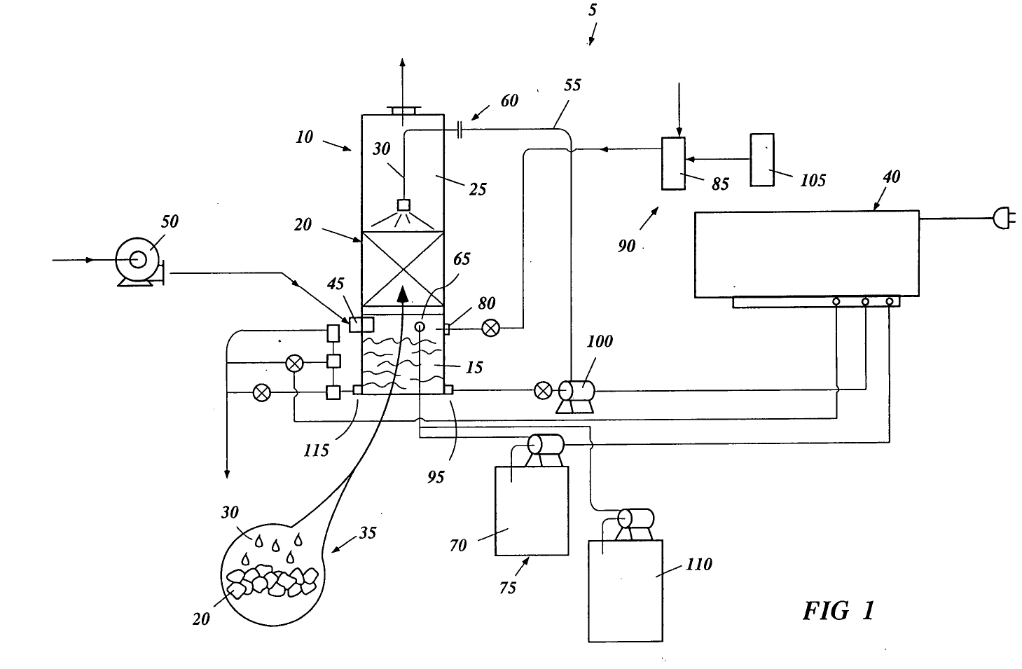

Turning now to FIG. 1, an apparatus for the removal of at least one odor-causing agent in accordance with one embodiment of the present invention is shown. The apparatus 5 for the removal of an odor-causing agent from a gas includes an adsorber 10 for the continual removal of an odor-causing agent from a gas. The adsorber 10 preferably includes a sump 15, a media bed 20, a exhaust chamber 25, a chemical fluid 30 entering the exhaust chamber 25, a regenerate contact surface 35 formed by a periodic deposit of the chemical fluid 30 from the exhaust chamber 25 on the media bed 20, and may further include a control means 40 for controlling the periodic deposit of the chemical fluid 30.

Preferably, the sump 15 includes a gas inlet 45 for receiving the gas, and the adsorber 10 is adapted to allow the gas to flow from the gas inlet 45 to the regenerate contact surface 35 so that at least one odor-causing agent is retained by the chemical fluid 30 upon contact of the odor-causing agent with the chemical fluid 30, thereby reducing the amount of odor-causing agent in the gas exiting from the exhaust chamber 25.

In one embodiment of the present invention, any suitable technology or technique (such as a fan 50 or similar device) may be used to pull or draw a gas having at least one odor-causing agent from a dirty air source. In this regard, the dirty air source may be a water or sewer line, well, pond, or similar water source. In one instance, the apparatus of the present invention may be used in a water treatment facility where hydrogen sulfide is the odor-causing agent removed from the gas.

In response to the action of the fan 55 the gas and odor-causing agent (dirty air) flow to a sump 15 having a gas inlet 45 for receiving the dirty air from the dirty air source. In one embodiment, the flow rate of the dirty air from the dirty air source to the sump 15 is approximately 1000 cubic feet of air per minute.

As will be understood by persons skilled in the art, the flow rate of the gas and odor-causing agent to the sump 15 may vary depending on, among other things, the amount of odor-causing agent to be removed, size of the adsorber 10, and availability of resources such as the chemical fluid 40 needed to remove the odor-causing agent from the dirty air, to name a few. Although the use of a fan 50 or suitable technology may be desirable to provide enhanced air flow (flow rate) from the dirty air source to the sump 15, the present invention may be utilized and the benefits realized without use of the fan 50 by providing a natural flow path for the gas to the sump 15.

As described herein, in one embodiment the flow of dirty air into the sump and contacting the regenerate contact surface 35, is substantially continual. This substantially continual flow of dirty air into the sump 15 permits the substantially continual removal of at least one odor-causing agent from the dirty air as the dirty air contacts the regenerate contact surface 35 formed by the periodic deposit of the chemical fluid 30 on the media bed 20. To contrast to other methods and apparatus known to the inventor that typically use a continuous or substantially continuous deposit of some type of absorbent suspension, reactionary substance, or other material/agent used for the purpose of removing the odor-causing agent from the dirty air, the present invention preferably uses a periodic deposit of the chemical fluid 30 to form the regenerate contact surface 35 for retaining the odor causing agent.

For example, U.S. Pat. No. 5,077,025, to Glass relates to a process and apparatus for purifying waste gases. Glass discloses to scrub with an adsorbent suspension that contains at least one finely dispersed adsorbent which is fed continuously to at least one gas-scrubbing device. In addition, as indicated above, according to one source at www.h2o2.com, generally, the simplest and most reliable type of scrubber is a packed-bed tower operated counter-currently; the hydrogen sulfide gas is moved upwards and the liquid hydrogen peroxide is moved downward. However, as further indicated, as this process requires an uninterrupted stream of chemical liquid to contact the constant influx of gas, large amounts of chemicals and water are consumed.

Other pollutant removal apparatus and methods contrast with the present invention by requiring contact between a liquid medium containing bacteria or aqueous suspension of microorganisms for some designated period of time in order to biodegrade the pollutants. I those other types of processes, the flow of dirty air is interrupted as the dirty air and biodegrading constituent interact. Typically this interaction occurs in some type of chamber or reactor. Accordingly, the flow of dirty air is intermittent or irregular making the continual removal of an odor-causing agent from the dirty air impractical. As a result, this type of system is inefficient, resulting in unsatisfactory performance due to low dirty air flow rates. To achieve significant flow rates such as those that can be practiced with the present invention, Glass' technology would require multiple reactors and/or traditional chemical absorbers.

As further shown in FIG. 1, a chemical fluid 30 preferably enters the exhaust chamber 25 via a chemical fluid supply line 55 connected at one end to a chemical port 60. In one embodiment, the sump 15 includes a chemical inlet 65 to receive a chemical 70 from a chemical supply source 75, a water inlet 80 to receive water 85 from a water supply source 90, and a chemical outlet 95 connected to the other end of the chemical fluid supply line 55 for transfer of the chemical 70 and/or fluid 30 to the exhaust chamber 25. In this embodiment, the chemical 70 is combined or mixed with water 85 in the sump 15 to form a chemical fluid 30 that is transferred along the chemical fluid supply line 55 for periodic deposit on a media bed 20. Likewise, in this example, a pumping means 100 such as a re-circulating pump or similar device may be positioned along the chemical fluid supply line 55 to facilitate or assist in the movement of the chemical fluid 30 along the chemical fluid supply line 55.

In a preferred embodiment, sodium hydroxide is the chemical 70 combined with water 85 to form the chemical fluid 30. However, persons of ordinary skill in the art will understand that other chemicals may be used with the principles described and utilized in accordance with the present invention. In this regard, the chemical 70 may be in a solid or powder form prior to being combined with the water 85. By combining the chemical powder with water 85 the chemical powder is substantially dissolved in the water 85 to form the chemical fluid 30. Alternatively, the chemical 70 may be furnished in liquid form where the addition of the chemical 70 generally requires no chemical reaction between the chemical 70 and water 85 to form the chemical fluid 30. The use of either chemical form or a combination of both chemical forms will depend on many factors including, among other things, the cost of each chemical form.

In another embodiment, the chemical 30 and water 85 may be mixed within the chemical fluid supply line 55. In other words, the chemical 70 may enter the chemical fluid supply line 55 at some point and the water 85 may enter the chemical fluid supply line 55 at the same point or at some other point along the chemical fluid supply line 55 path where the two constituents have an opportunity to combine/interact to form the chemical fluid 30 before being periodically deposited on the media bed 20. In this embodiment, combining of the chemical 70 and water 85 occurs outside of the sump 15. Accordingly, in this embodiment, the sump 15 is primarily used to receive the gas and odor-causing agent after washing of the regenerate contact surface 35 takes place, as described herein.

In still another embodiment, the chemical 70 (powder and/or liquid) may be periodically deposited on the media bed 20. In a separate application, water 85 may then be periodically added to the chemical 70 already located or positioned on the media bed 20. Accordingly, the periodic combining of each of the chemical 70 and water 85 to form the chemical fluid 30 may take place on the media bed 20 within the exhaust chamber 25.

Therefore, depending on the particular embodiment, the sump 15 may function to receive (1) the gas and the odor-causing agent; (2) the gas, the odor-causing agent, and chemical 70, or (3) the gas, the odor-causing agent, the chemical 70, and water 85.

Regardless of how the chemical 70 and water 85 are combined to form the chemical fluid 30, the chemical fluid 30 is preferably only periodically deposited on the media bed 20 to form a regenerate contact surface 35. When compared to other odor removal methods and apparatus that utilize a chemical and/or material combination that are continuously supplied during the process of removing the odor-causing agent, the present invention, by one account, reduces water consumption by ninety (90%) percent and the consumption of chemical constituents by eighty (80%) percent.

As described herein, the chemical 70 and water 85 are typically combined to form the chemical fluid 30. In this regard, the chemical fluid 30 includes a mixture of sodium hydroxide and water 85. In a preferred embodiment of the present invention, the percent of sodium hydroxide to water is from about 0.010 percent to about 2.0 percent. The fluid mixture 30 may have sodium hydroxide constituting approximately one-half of one percent (0.005%) of the sodium hydroxide and water mixture. Similarly, the fluid mixture 30 including at least sodium hydroxide and water may be expressed as having a potential of hydrogen (pH) of approximately thirteen (13). In alternative embodiments, the percent of sodium hydroxide to water is from about 0.025 percent to about 1.0 percent, or from about 0.040 percent to about 0.750 percent.

Other elements may be added to the chemical fluid 30 to change or modify the properties of the chemical fluid 30. For example, a water softener 105 may be added to the chemical fluid 30 to remove calcium from the water 85 and/or chlorine 110 may be added to speed up the disassociation of hydrogen sulfide. Persons of ordinary skill in the art will understand that other elements may be separately added to the chemical fluid 30 or in combination with other materials/elements as needed for various purposes intended by the user.

The present invention preferably includes a media bed 20, that, when combined with the chemical fluid 30, forms a regenerate contact surface 35. The media bed 20 may be composed of any suitable material, such as activated charcoal, volcanic rock, or other similar material(s). In one embodiment, the regenerate contact surface 35 acts as a catalyst bed and does not enter into the reaction between the chemical fluid 30 and the odor-causing agent of the dirty air. In other words, the chemical fluid 30 is periodically deposited on the media bed 20 to form the regenerate contact surface 35 where interaction between the chemical fluid 30 and at least one odor-causing agent takes place to remove the odor-causing agent from the dirty air. When removing the odor-causing agent hydrogen sulfide, the interaction of hydrogen sulfide in the presence of sodium hydroxide and water typically can be expressed by the equation:
H₂O+3H₂S+2NaOH→H₂O+2NaS+4H₂+SO₂+Heat

After at least some of the odor-causing agent is removed from the dirty air and retained on the regenerate contact surface 35 (albeit in another form) the odor-causing agent preferably is then periodically washed from the regenerate contact surface 35 with a subsequent deposit or re-deposit of chemical fluid 30 on the regenerate contact surface 35. The odor-causing agent that is washed from the regenerate contact surface 35 is typically collected in the sump 15 and periodically drained to eliminate the odor-causing agent from the system 5.

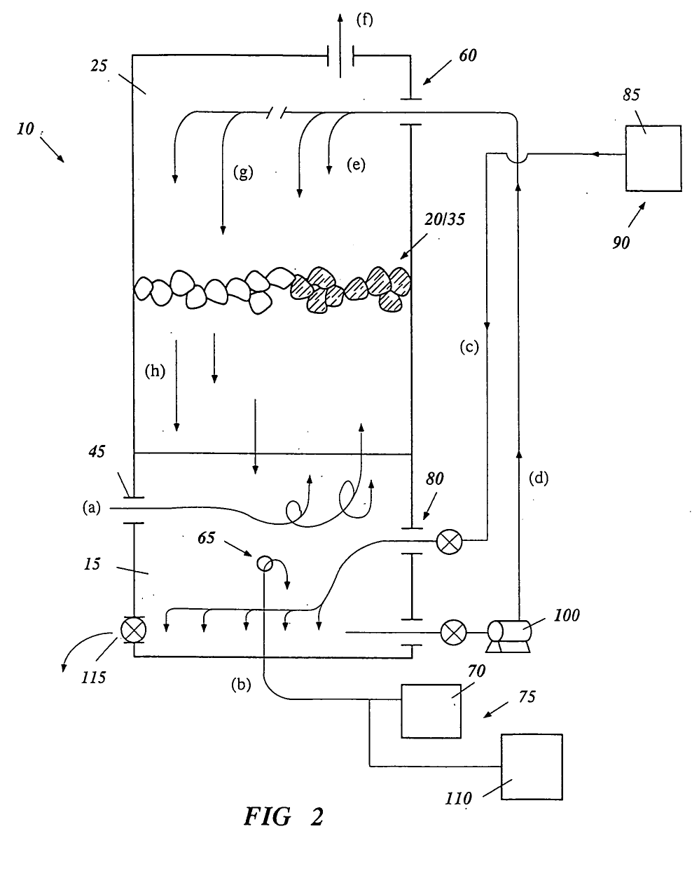

Turning now to FIG. 2, a more detailed cut-away view of an adsorber in accordance with one embodiment of the present invention is shown. Dirty air flows into the sump 15 through a gas inlet 45 as indicated by arrow (a). As described herein, a fan 50 or similar device may facilitate the flow of dirty air into the sump 15. Once inside the sump 15, the dirty air rises toward the media bed 20 as indicated by the upwardly directed section of arrow (a). A chemical 70, preferably sodium hydroxide, enters the sump 15 through a chemical inlet 65 along pathway (b) where the chemical 70 combines with water 85 entering the sump 15 through the water inlet 80 from pathway (c) to form a chemical fluid 30. The chemical fluid 30 flows along a pathway represented by arrow (d) and enters the exhaust chamber 25 through a chemical port 60 connected to one end of a chemical fluid supply line 55. The flow of chemical fluid 30 into the exhaust chamber 25 may be facilitated or aided by a pumping means 100 such as a re-circulating pump or similar device. As shown by the activity on the right side of the adsorber 10, a first or initial deposit (e) of the chemical fluid 30 is substantially retained by the media bed 20, now referred to as a regenerate contact surface 35. Persons of ordinary skill in the art will understand that the adsorber 10 shown in FIG. 2 is divided into right and left segments for ease of explanation, and any activities as described herein as occurring on one side of the adsorber 10 preferably applies equally to the other side of the adsorber 10.

Continuing with FIG. 2, after entering the sump 15 the dirty air/gas rises until the dirty air contacts the regenerate contact surface 35. In this regard, the adsorber 10 is configured to allow the gas to flow from the gas inlet 45 to the regenerated contact surface 35 so that at least some of the odor-causing agent is retained by the chemical fluid 30 upon contact of the odor-causing agent with the chemical fluid 30, thereby reducing the amount of odor-causing agent in the gas flowing out of the exhaust chamber 25 (as shown by arrow (f)). Preferably, the flow of dirty air contacting the regenerate contact surface 35 and the resulting removal of at least one odor-causing agent from the dirty air during this operational phase is continual (even though the dispense/deposit of chemical fluid 30 is preferably periodic).

Although the media bed 20 is shown in FIG. 2 as composed of a single layer, persons of ordinary skill in the art will understand that a multi-layered media bed or a plurality of separate media bed layers each capable of having a chemical fluid 30 periodically deposited thereon to form a plurality of regenerate contact surfaces 35 is within the scope and spirit of the present invention. For example, a plurality of media beds may be positioned such that one media bed is positioned substantially above a second media bed. Likewise, a third media bed may be positioned substantially above the second media bed. This positioning or “stacking” of media beds can be repeated many times until a final level or degree of potential filtering is achieved.

As will be further understood by persons of ordinary skill in the art, the distance between each media bed layer may vary depending on various factors. For example, the distance between the first and second media bed may be a certain distance while the distance between the second and third media bed may be a different distance. Likewise, the distance between each media layer may be substantially the same.

As used herein, the term “continual” or “substantially continual” is a broad term generally used in its ordinary meaning and includes, without limitation, the ability of the present invention to operate essentially non-stop in the operational phase if so intended by the end user. In this regard, and as mentioned above, the continual odor removing capabilities of the invention contrasts with the invention's preferred intermittent or periodic re-deposit of the chemical fluid 30 on the regenerate contact surface 35. For efficiency purposes, as described herein, continual or substantially continual removal of an odor-causing agent is a preferred embodiment of present invention. However, persons of ordinary skill in the art will understand that the present invention, as described herein, may be operated at least in the operational phase for any length of time depending on, among other things, the economic and/or material resources, manpower, and operating conditions/environment available to the end user.

As used herein, the term “end user” is a broad term generally used in its ordinary meaning and includes, without limitation, any person or entity (person and/or business including agents thereof) that actually uses the method(s) and/or apparatus in accordance with the present invention as described herein.

As noted above, the deposit of the chemical fluid 30 on the regenerate contact surface 35 preferably occurs periodically: in one example, the deposit may occur once in every twenty-four hours, and the “deposit” step may be completed in about 30-60 minutes. However, persons of ordinary skill in the art will understand that depending on various factors including, among other things, the size or surface area of the regenerate contact surface 35, flow volume of dirty air, and/or concentration of odor-causing agent in the gas, the periodic deposit of chemical fluid 30 on the regenerate contact surface 35 may occur more or less frequently than once in every twenty-four hours. By requiring only a periodic deposit of the chemical fluid 30, the present invention provides a more reliable and efficient method and apparatus for removing an odor-causing agent from a gas than other methods and apparatus known to the inventor.

In this regard, the present invention is more reliable due to the preferably passive nature of the system during the operational phase. In other words, no pumping or other mechanical activity of equipment or components other than a fan 50, if used, typically occurs for approximately 24 hours when the chemical fluid 30 is re-deposited on the regenerate contact surface 35. Typically, the mechanical inactivity of equipment and/or components result in less maintenance or down-time and greater reliability when compared to odor removing systems known to the inventor. Similarly, the present invention is more efficient due to a continual or substantially continual odor removal operational phase while requiring only a periodic deposit of chemical fluid 35, resulting in a high ratio of odor-causing agent removal yield to chemical fluid 35 expenditure as compared to other odor removal systems known to the inventor.

As shown by arrows (g) and the activity on the left side of the adsorber 10 in FIG. 2, the periodic deposit of the chemical fluid 30 on the regenerate contact surface 35 preferably acts both to remove the retained odor-causing agent from the regenerate contact surface 35 and to re-establish or renew the capacity or ability of the regenerate contact surface 35 to retain odor-causing agent. Removal of the odor-causing agent by the periodic deposit of the chemical fluid 30 on the regenerate contact surface 35 is shown by arrows (h). In this manner, at least one odor-causing agent preferably is substantially removed from the dirty air. In one embodiment, the sump 15 receives the retained odor-causing agent after removal of the odor-causing agent from the regenerate contact surface 35. Preferably, the sump 15 is purged of odor-causing agent about once every twenty-four hours. This purging can be coordinated with the aforementioned deposit of the chemical fluid 30 or may be done independent of the deposit of the chemical fluid 30. Purging of the sump 15 may be done with a variety of methods including, by way of example and not limitation, a purge outlet 115 positioned on the sump 15.

Control of the period deposit of chemical fluid 30 on the regenerate contact surface 35 may be accomplished manually, and/or automatically through the use of a control means 40 such as a program-logic or similar device. Among other things, automatic sensors can be used to determine the need for re-depositing the chemical fluid 30 on the media bed 20. For example, sensors may be used to detect, among other things, the flow volume of dirty air, and/or concentration of odor-causing agent in the gas so that the periodic deposit of chemical fluid 30 on the regenerate contact surface 35 may occur more or less frequently than once in every twenty-four hours. Alternatively, the control means 40 may simply act as a timer for controlling various mechanical and/or electrical aspects of the present invention.

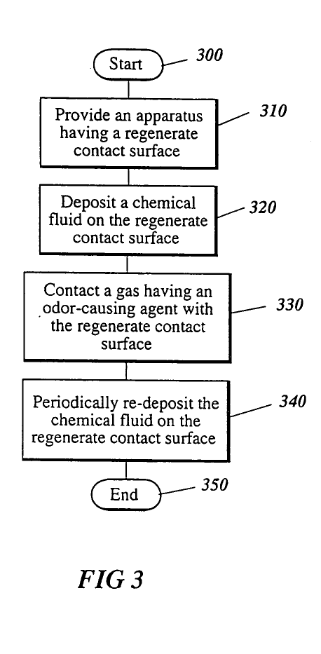

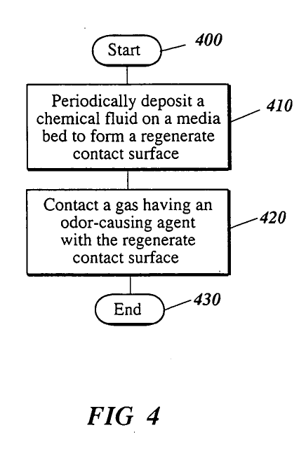

Turning now to FIGS. 3 and 4, flow charts illustrating methods of removing an odor-causing from a gas in accordance with the present invention are shown. For convenience, in one embodiment, the method described herein begins by providing an apparatus for the removal of odor-causing agent from a gas, that is, prior to the removal of at least one odor-causing agent from the gas through contact of the odor-causing agent with a regenerate contact surface. Alternatively, the method described herein may begin after an odor-causing agent is removed from the gas. Furthermore, the continuation, or interruption of step(s) once started is entirely dependent upon the initial starting condition of the odor removing apparatus, as described herein, and the system's desired final condition or state. For example, the process may begin with the re-deposit of the chemical fluid on the regenerate contact surface or the process may begin with contacting the dirty air with the regenerate contact surface. Therefore, although the method of the present invention is illustrated herein with steps occurring in a certain order, the specific order of the steps, or any continuation or interruption between steps, is not required.

Turning now to FIG. 3, the process begins at step 300. At step 310, an apparatus having a regenerate contact surface for the substantially continual removal of an odor-causing agent from a gas as described herein is provided. Among other things, a manufacturer, distributor, or other third party may supply the device. In this respect, “providing” the device is intended to refer to the fact that such a device is in fact present in use with the method, and so the device alternatively may be provided by the actual user thereof.

A preferred process continues at step 320 with depositing a chemical fluid, as described herein, on the regenerate contact surface. The process further includes step 330, contacting the gas with the regenerate contact surface so that at least some of the odor-causing agent is retained by the chemical fluid upon contact of the odor-causing agent with the chemical fluid, thereby reducing the amount of odor-causing agent in the gas. At step 340, the process continues by periodically re-depositing the chemical fluid to both wash and re-establish or re-new the capacity of the regenerate contact surface to remove an odor-causing agent from a gas. The process ends at step 350.

A flow chart illustrating an alternative method of removing an odor-causing from a gas in accordance with the present invention is shown in FIG. 4. The alternative process begins at step 400. At step 410, the process continues with the step of periodically depositing a chemical fluid on a media bed to form a regenerate contact surface. The process further continues at step 420 with contacting a gas having an odor-causing agent with the regenerate contact surface such that at least some of the odor-causing agent is retained by the chemical fluid upon contact of the odor-causing agent with the chemical fluid thereby reducing the amount of odor-causing agent in the gas. The periodic deposit of the chemical fluid refreshes, re-establishes, or re-news the chemical fluid on the regenerate contact surface resulting in the substantially continuous removal of the odor-causing agent from the gas. Similar to the aforementioned process, the step of periodically depositing a chemical fluid on the regenerate contact surface further acts to remove at least some of the retained odor-causing agent from the regenerate surface. The process ends at step 430.

The apparatus and methods of the present invention have been described with some particularity, but the specific designs, constructions and steps disclosed are not to be taken as delimiting of the invention. Obvious modifications will make themselves apparent to those of ordinary skill in the art, all of which will not depart from the essence of the invention and all such changes and modifications are intended to be encompassed within the appended claims.

1. An apparatus for filtering, comprising:
an adsorber for the continual removal of a constituent from a gas; the adsorber including a sump, a media bed, and an exhaust chamber;
a chemical fluid entering the exhaust chamber;
a regenerate contact surface formed by a periodic deposit of the chemical fluid from the exhaust chamber on the media bed; and
a control means for controlling the periodic deposit of the chemical fluid;
wherein the sump includes a gas inlet for receiving the gas; and
wherein the adsorber is configured to allow the gas to flow from the gas inlet to the regenerate contact surface so that at least some of the constituent is retained by the chemical fluid upon contact of the constituent with the chemical fluid thereby reducing the amount of constituent in the gas flowing out of the exhaust chamber.

2. The apparatus of claim 1, wherein the exhaust chamber includes a chemical port having one end of a chemical fluid supply line connected thereto.

3. The apparatus of claim 2, wherein the chemical fluid includes a mixture of a chemical and water, and the sump further includes a chemical inlet to receive the chemical, a water inlet to receive the water, and a chemical fluid outlet connected to the other end of the chemical fluid supply line.

4. The apparatus of claim 3, further including a pumping means to pump the chemical fluid from the sump to the exhaust chamber via the chemical supply line.

5. The apparatus of claim 1, wherein the media bed is composed of activated charcoal.

6. The apparatus of claim 1, wherein the media bed is composed of volcanic rock.

7. The apparatus of claim 1, further including a controller for automatically controlling the periodic deposit of chemical fluid.

8. The apparatus of claim 7, wherein the controller is a program-logic control device.

9. The apparatus of claim 1, wherein the chemical fluid includes a mixture of water and sodium hydroxide.

10. The apparatus of claim 9, wherein the percent of sodium hydroxide to water is from about 0.010 percent to about 2.0 percent.

11. The apparatus of claim 9, wherein the percent of sodium hydroxide to water is from about 0.025 percent to about 1.0 percent.

12. The apparatus of claim 9, wherein the percent of sodium hydroxide to water is from about 0.040 percent to about 0.750 percent.

13. The apparatus of claim 9, wherein the sodium hydroxide constitutes approximately one-half of one percent of the chemical fluid mixture.

14. The apparatus of claim 9, wherein the chemical fluid has a potential of hydrogen (pH) of approximately thirteen.

15. The apparatus of claim 9, wherein the chemical fluid further includes a water softener to remove calcium from the water.

16. The apparatus of claim 1, further including a standby tank containing a chemical additive for addition to the chemical fluid.

17. The apparatus of claim 16, wherein the chemical additive is chlorine.

18. The apparatus of claim 1, wherein the constituent is an odor-causing agent.

19. An apparatus for the removal of a contaminant from a gas, comprising:
a chemical fluid;
an adsorber having a regenerate contact surface for the substantially continual removal of an contaminant from a gas;
a control means for controlling a periodic deposit of the chemical fluid on the regenerate contact surface, at least a portion of the contaminant in the gas being retained by the chemical fluid upon contact of the contaminant with the chemical fluid thereby reducing the amount of contaminant in the gas, the periodic deposit of the chemical fluid on the regenerate contact surface acting both to remove the retained contaminate from the regenerate contact surface and to re-establish the chemical fluid on the regenerate contact surface.

20. The apparatus of claim 19, wherein the periodic deposit of the chemical fluid on the regenerate contact surface is done at least once every twenty-four hours.

21. The apparatus of claim 19, wherein operation of the adsorber and the periodic deposit of the chemical fluid is automatically controlled by a controller.

22. The apparatus of claim 21, wherein the controller is a program-logic control device.

23. The apparatus of claim 19, wherein the chemical fluid is a mixture of water and sodium hydroxide.

24. The apparatus of claim 23, wherein the percent of sodium hydroxide to water is from about 0.010 percent to about 2.0 percent.

25. The apparatus of claim 23, wherein the percent of sodium hydroxide to water is from about 0.025 percent to about 1.0 percent.

26. The apparatus of claim 23, wherein the percent of sodium hydroxide to water is from about 0.040 percent to about 0.750 percent.

27. The apparatus of claim 23, wherein the mixture of water and sodium hydroxide has a potential of hydrogen (pH) of approximately thirteen.

28. The apparatus of claim 23, wherein the sodium hydroxide constitutes approximately one-half of one percent of the chemical fluid mixture.

29. The apparatus of claim 19, wherein the adsorber further includes an exhaust chamber, a chemical fluid supply line, and a sump;
wherein the sump includes an inlet for receiving the gas, the adsorber is configured to allow the gas to flow from the sump to the regenerate contact surface, the exhaust chamber includes a chemical port connected to one end of the chemical fluid supply line for receiving the chemical fluid and for depositing the chemical fluid on the regenerate contact surface, and
wherein the sump receives the retained odor-causing agent after removal of the odor-causing agent from the regenerate contact surface.

30. The apparatus of claim 29, wherein the sump further includes a chemical inlet to receive the chemical fluid and a chemical outlet connected to the other end of the chemical fluid supply line.

31. A method for filtering, comprising the steps of:
(a) providing an adsorber having a regenerate contact surface for the substantially continual removal of a constituent from a gas;
(c) depositing a chemical fluid on the regenerate contact surface;
(b) contacting the gas with the regenerate contact surface so that at least some of the constituent is retained by the chemical fluid upon contact of the constituent with the chemical fluid thereby reducing the amount of constituent in the gas; and
(d) periodically re-depositing the chemical fluid to both wash and re-new the capacity of the regenerate contact surface.

32. The method of claim 31, wherein the periodic deposit of chemical fluid is automatically controlled by a controller.

33. The method of claim 31, wherein the step of depositing chemical fluid on the regenerate contact surface is done at least once every twenty-four hours.

34. The method of claim 31, wherein the chemical fluid is a mixture of water and sodium hydroxide.

35. The method of claim 34, wherein the mixture of water and sodium hydroxide has a potential of hydrogen (pH) of approximately thirteen.

36. The method of claim 34, wherein the sodium hydroxide constitutes approximately one-half of one percent of the chemical fluid mixture.

37. The method of claim 31, further including the step of receiving retained odor-causing agent washed from the regenerate contact surface into a sump.

38. The method of claim 37, further including the step of draining the sump to remove the odor-causing agent from the adsorber.

39. The method of claim 38, wherein the step of draining the sump is done at least once every twenty-four hours.

40. The method of claim 31, wherein the constituent is an odor-causing agent.

41. A method for the removal of an odor-causing agent from a gas, comprising the steps of:
periodically depositing a chemical fluid on a media bed to form a regenerate contact surface; and
contacting a gas having an odor-causing agent with the regenerate contact surface such that at least some of the odor-causing agent is retained by the chemical fluid upon contact of the odor-causing agent with the chemical fluid thereby reducing the amount of odor-causing agent in the gas;
wherein the periodic deposit of the chemical fluid refreshes the chemical fluid on the regenerate contact surface resulting in the substantially continuous removal of the odor-causing agent.

42. The method of claim 41, wherein the step of periodically depositing a chemical fluid on the regenerate contact surface acts to remove at least some of the retained odor-causing agent from the regenerate surface.

43. A method for filtering, comprising the steps of:
(a) providing the apparatus of claim 1 or 19 for the removal of odor from a gas;
(b) depositing a chemical fluid on the regenerate contact surface;
(c) contacting the gas with the regenerate contact surface so that at least some of the odor-causing agent is retained by the chemical fluid upon contact of the odor-causing agent with the chemical fluid thereby reducing the amount of odor-causing agent in the gas; and
(d) periodically re-depositing the chemical fluid to both wash and re-new the capacity of the regenerate contact surface.

44. A method for filtering, comprising the steps of:
(a) providing the apparatus of claim 1 or 19 for the removal of odor from a gas;
(b) periodically depositing a chemical fluid on the media bed to form a regenerate contact surface; and
(c) contacting a gas having an odor-causing agent with the regenerate contact surface such that at least some of the odor-causing agent is retained by the chemical fluid upon contact of the odor-causing agent with the chemical fluid thereby reducing the amount of odor-causing agent in the gas;
wherein the periodic deposit of the chemical fluid refreshes the chemical fluid on the regenerate contact surface resulting in the substantially continuous removal of the odor-causing agent.
